(19) United States
(12) Patent Application Publication
(10) Pub. No.: US 2007/0226353 A1
(43) Pub. Date: Sep. 27, 2007

(54) System and method for providing and maintaining dynamic media

(76) Inventor: George Eino Ruul, Applecross (AU)

Correspondence Address: CARR & FERRELL LLP, 2200 GENG ROAD, PALO ALTO, CA, 94303, US

(21) Appl. No.: 11/586,122

(22) Filed: Oct. 25, 2006

Related U.S. Application Data
(60) Provisional application No. 60/785,655, filed on Mar. 24, 2006.

(51) Int. Cl. G06F 15/16

(52) U.S. Cl. 709/227

(57) ABSTRACT

Exemplary systems and methods for creating and maintaining dynamic media are provided. In exemplary embodiments, selection of a dynamic media triggers communication with the media provider. The media provider then provides the dynamic media to the user. In exemplary embodiments, the dynamic media may be customized to user preferences and/or user past behavior. Dynamic media may also be targeted to specific users based on user preferences and/or user past behavior.

### CROSS REFERENCE TO RELATED APPLICATION

The present application claims the priority benefit of U.S. Provisional Patent Application No. 60/785,655, filed Mar. 24, 2006 and entitled “Dynamic and Interactive Advertising System,” which is herein incorporated by reference. The present application is related to co-pending U.S. patent application Ser. No. ______ entitled “System and Method for Providing Dynamic Media,” U.S. patent application Ser. No. ______ entitled “System and Method for Transferring Media,” U.S. patent application Ser. No. ______ entitled “System and Method for Maintaining a History of Transferable and Updatable Media” all filed concurrently with the present application. The present application is further related to co-pending U.S. patent application Ser. No. 11/214,515 entitled “Managed E-Commerce Trading,” filed Aug. 29, 2005; U.S. patent application Ser. No. 11/250,996 entitled “E-Commerce with Direct Access to Real-Time Inventory,” filed Oct. 14, 2005; U.S. patent application Ser. No. 11/251,316 entitled “Managed E-Commerce Trading Environments,” filed Oct. 14, 2005; and U.S. patent application Ser. No. 11/258,419 entitled “Content Monitor,” filed Oct. 24, 2005, all of which are herein incorporated by reference.

### BACKGROUND OF THE INVENTION

1. Field of the Invention

Embodiments of the present invention relate generally to media and more particularly to providing and maintaining dynamic media.

2. Description of Related Art

The Internet has developed into a dominant force in the global business market. Media such as movie clips, sound or music clips, articles, essays, recipes, advertisements, and advice columns may be posted by media providers for consumers to view. Businesses may now sell products, deal with vendors, post advertisements, promote items, and conduct other business activities via the Internet. For large businesses, frequently posting media to reach out to users is relatively easy. Smaller businesses, however, may not have the capability to do the same.

Typically, the media that a user sees while on particular websites are posted for a limited period of time. So if, for example, the user is too busy or not interested enough at the moment to investigate the media, the user may be unable to retrieve the media at a later time. For example, as Internet advertisements are frequently updated or changed by websites, it is often difficult for a user to find an advertisement that had been previously posted. Therefore, the media provider has lost a potential user or customer simply because the user can not find the media. Users may then go to another media provider when the user had more time or interest in the media.

An additional shortcoming of current online media is that the media can not be customized to the user. If the user wants to see more relevant information regarding a particular media, the user may need to visit the media provider's website and search for the more relevant information. Alternatively, the user may go to a search engine and search for the relevant information, thus losing the potential user for the media provider without the customized media.

Therefore, there is a need for a dynamic media which may be customizable for a user.

### SUMMARY OF THE INVENTION

Embodiments of the present invention provide systems and methods for providing and maintaining dynamic media. In exemplary embodiments, the dynamic media comprises a media identifier configured to identify the dynamic media and a parent address configured to provide contact information for a media provider of the dynamic media. Communication may be triggered with the media provider associated with the parent address when the dynamic media is selected.

Via the communication, the media provider provides the dynamic media based on the media identifier to a user. In some embodiments, the dynamic media may be customized to the user. The customization may be based on user preferences or past behavior. The dynamic media may also be updated or replaced.

In some embodiments, the media provider may target dynamic media to users. The media provider accesses and reviews user preferences and/or past behaviors in order to determine if a dynamic media is relevant to a user. If the dynamic media is relevant, the media provider may send the dynamic media to the user, send an invitation to obtain the dynamic media, or provide the dynamic media as an update or replacement to an existing dynamic media at a user device.

### BRIEF DESCRIPTION OF THE DRAWINGS

FIG. 1 is an exemplary environment in which embodiments of the present invention may be practiced;

FIG. 2A is a block diagram of an exemplary dynamic media;

FIG. 2B is an example dynamic media;

FIG. 3 is a block diagram of an exemplary online services server according to one embodiment of the present invention;

FIG. 4 is a block diagram of an exemplary media provider computing device;

FIG. 5 is a block diagram of an exemplary media provider media engine;

FIG. 6 is a schematic of exemplary communications between various components which enable embodiments of the present invention;

FIG. 7 is a flowchart of an exemplary method for providing dynamic media to a user;

FIG. 8 is a flowchart of an exemplary method for customizing the dynamic media to the user; and

FIG. 9 is a flowchart of an exemplary method for targeting media to the user.

### DETAILED DESCRIPTION OF EXEMPLARY EMBODIMENTS

Embodiments of the present invention provide a system which enables providing and maintaining dynamic media at a user device. In exemplary embodiments, dynamic media may be transferred to a user's computing device and be updated with current media provider information or targeted media as needed. The dynamic media may also be customized according to user preferences and behaviors.

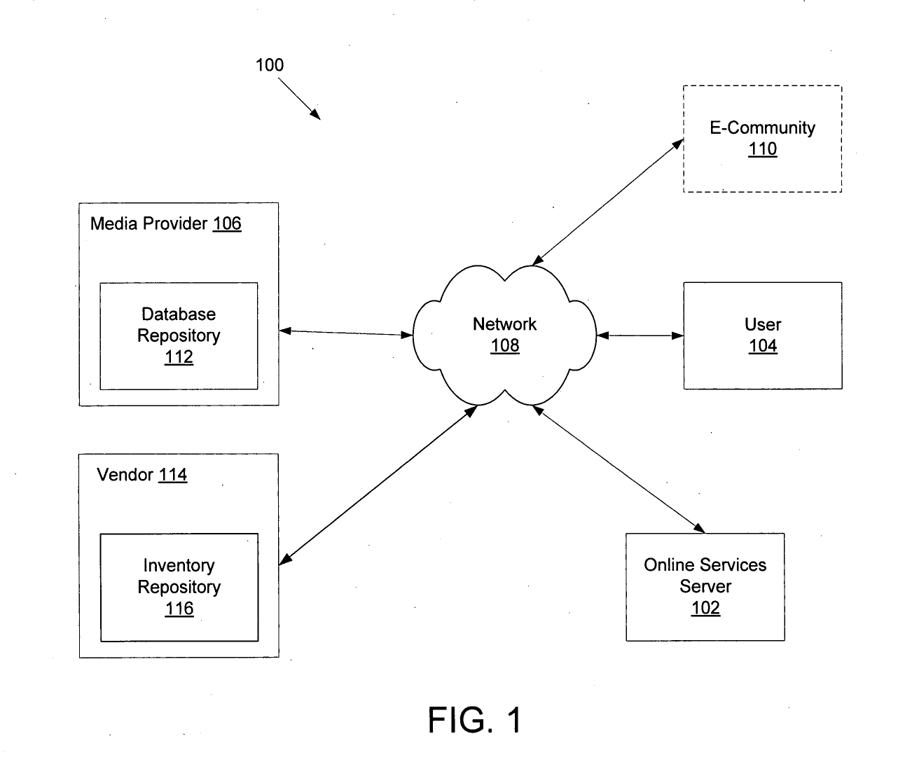

FIG. 1 shows an exemplary environment 100 in which embodiments of the present invention may be practiced. The environment 100 comprises an online services server 102, at least one user 104, and at least one media provider 106 all coupled for communication via a network 108. In exemplary embodiments, the network 108 may be the Internet, wide area network, local area network, or any other type of communication network. The online services server 102, a computing device of the user 104, and a computing device of the media provider 106 will be discussed in more detail below. In some embodiments, one or more optional e-communities 110 (i.e., groups of users sharing a common interest) may also be present in the environment 100.

The present environment 100 allows a plurality of users 104, media providers 106, and optional e-communities 110 to interact with each other. The interactions may result in online transactions or exchange of information. In the present embodiment, the media provider 106 provides dynamic media to the environment 100. The media provider 106 may comprise news outlets, content providers, marketing firms, advertising firms, or any entity which may manage online advertising and marketing strategies. The dynamic media may be presented, for example, on webpages, pop-ups, and banner ads. Additionally, the dynamic media may be presented in e-mail communications or shared between members of the environment 100 (e.g., users 104, media providers 106, and optional e-communities 110). Updates to the dynamic media may be provided via a database repository 112. In exemplary embodiments, the database repository 112 comprises a real-time database having up-to-the-minute data. The database repository 112 may also comprise a media database containing the different media the media provider 106 can provide.

Dynamic media may comprise any item of information found on the network 108 that is configured to function with embodiments of the present invention. For example, the dynamic media may be an advertisement or news article that is identified as one that can function in the environment 100. The identifier may be a symbol or any other indicator that the media is operable in the environment 100.

In a specific embodiment, the media provider 106 is a vendor 114. In exemplary embodiments, the dynamic media from the vendor 114 (e.g., advertisement) is updatable with vendor information from a data repository comprising an inventory repository 116. The exemplary inventory repository 116 comprises a current, real-time database maintained by the vendor 114, which comprises inventory information including inventory amount and pricing. Typically, the inventory repository 116 is located at the vendor's location and tracks pricing and movement of the vendor's inventory. In some embodiments, an advertisement provider may be coupled to the vendor 114 to provide the dynamic media on behalf of the vendor 114.

In exemplary embodiments of the present invention, the members of the environment 100 communicate over the network 108 using a specialized GUID-over-IP transport mechanism. The specialized transport mechanism allows the members to be coupled through a network of internal and external routers, proxies, and firewalls without requiring reconfiguration of various communications equipment. Routing management may be used to control pathways taken by communicating entities. Additionally, load balancing and N-tier construction allow for efficient scale out rather than scale up implementations.

The coupled computing devices of the members of the environment 100 may each comprise a core services module which allows operation of embodiments of the present invention. The core services module will be discussed in more detail below.

In exemplary embodiments, the dynamic media is transferred to a location designated by the user 104 selecting the dynamic media. In one embodiment, the selection is via a “drag and drop” command. “Drag and drop” as utilized herein may refer to selecting and moving a copy or version of the transferable media to a designated location, generating a copy of the transferable media at the designated location, or creating a direct link to the transferable media at the designated location.

In exemplary embodiments utilizing a standard browser, when a dynamic media is selected, a script language (e.g., a Visual Basic script or Java script) embedded into a HTML section of the dynamic media is activated (e.g., JAVA functions or active X control). This script interacts with the core services module at the user 104 device, which recognizes that the media is a dynamic media having a particular media identifier and a parent identifier. A connection is then made via the script and the core services module to the media provider 106 identified by the parent identifier, which can then provide instructions and data to display a version of the dynamic media at the user 104 device. The data may allow for an exact duplicate of the dynamic media the user 104 selected or a customized version of the dynamic media. While the result may appear to be a “drag and drop” in these embodiments, in reality, it is an instruct and recreate process. In a further embodiment, the dynamic media as displayed on a web page, for example, is extracted and utilized to display the dynamic media on the user's desktop, even if the user is offline at that time. However, any action based on a real time link is curtailed until reconnection occurs.

In some embodiments utilizing an online services application, a version of the dynamic media can be “copied and pasted.” That is, every component that is embedded in the dynamic media can be copied and moved over to the designated location.

In yet further embodiments, the media may literally be “dragged and dropped” from a first location to a second location (i.e., taken from the first location and dropped onto a second location). For example, a media may be dragged from the desktop of the user 104 to an e-mail to be sent to another user. In these embodiments, the trigger or select event is a “drag and drop” command received from the user 104.

While some of the above embodiments describe a media constructed in, or containing at least a section of, HTML, alternative embodiments of the media may be constructed using other formats. For example, the media may be constructed using Macromedia's Flash, XML using XSLT, or any other potential construct language that can trigger the select event. The “select” event may cause the media to be transferred, copied, or dropped, or may cause a connection to the media provider 106 to be established.

It should be noted that the environment 100 of FIG. 1 is exemplary. Alternative embodiments may comprise more or fewer components. For example, more than one online services server 102 may be provided (e.g., regionally based). Furthermore, any number of users 104, media providers 106, e-communities 110, vendors 114, and advertisement providers may be coupled in communication in the environment 100 at any time.

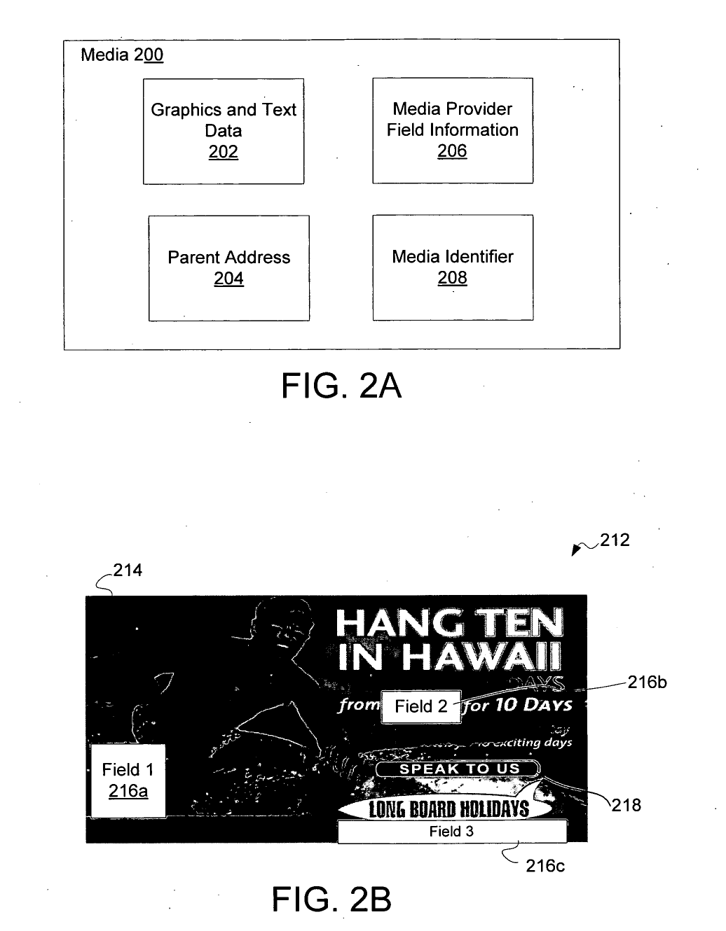

Referring now to FIG. 2A, a block diagram of an exemplary dynamic media 200 is shown. A version of the dynamic media 200 can be “dragged and dropped” onto the user's 104 desktop or transferred to another user. Although the dynamic media 200 may not actually be dragged from one location and dropped on a second location, the operation of the various components of the core services modules function to make it appear as a simple “drag and drop” operation.

In some embodiments, the version of the dynamic media 200 may additionally be customized to the user preferences or updated as the media provider's database repository 112 changes. In exemplary embodiments, the dynamic media 200 (or version of the media 200) comprises graphics and text data 202, a parent address 204, optional media provider field information 206, and a media identifier 208.

In non-customizable media embodiments, the exemplary graphics and text data 202 may comprise data for the entire dynamic media. That is, the graphics and text data 202 is all that is required in order to locally generate the dynamic media for display.

In customizable media embodiments, the exemplary graphics and text data 202 comprises data for parts of the dynamic media 200 that are static (i.e., not customized or updated). The static data may include the media provider's logo, fixed text or images, and dimensions of the dynamic media 200. Further, the graphics and text data 202 may include metadata about fields in which the optional media provider field information 206 is merged for a customizable dynamic media.

The parent address 204 is an identifier indicating a media provider 106 and contact information for the media provider 106. As previously discussed, the media provider 106 may be a news provider, an online magazine or website, vendor 114, or other publisher of online content. When the dynamic media is selected for transfer, the user 104 device may relay a message to the media provider 106 using the parent address 204 so that the dynamic media can be transferred, updated, or customized to the recipient.

The optional media provider field information 206 comprises information transferred to the user 104 from the media provider 106. The media provider field information 206 may include information used to customize or update the version of the dynamic media 200 when the dynamic media 200 is dragged and dropped to the user 104 or transferred to another user. The media provider field information 206 can be transferred with the dynamic media 200. In an alternative embodiment, a set of field information may be transferred with the version of the dynamic media 200. The client 104 device then selects the field information 206 from the set according to the user preferences as discussed herein.

The media identifier 208 is used to identify a specific version of the dynamic media 200 that the user 104 views due to customizing or updating of the dynamic media 200. The media identifier 208 may be tracked by the media provider 106 to maintain a history of the dynamic media 200. The media identifier 208 may also change, for example, when the dynamic media 200 is dragged and dropped by the user 104 and when the dynamic media 200 is received by another user after being transferred.

Referring now to FIG. 2B, an example dynamic media 212 is shown. In the present example, the dynamic media 212 is an advertisement for a Hawaiian vacation. The graphics and text data 202 is shown as media body 214 having optional fields 216 and an optional link 218. The media body 214 has a length dimension and a width dimension dictated by the graphics and text data 202. The graphics and text data 202 may also include image, text, and designated locations and dimensions for optional fields 216. In one embodiment, the graphics and text data 202 comprises the entire dynamic media.

The media body 214 may also comprise an optional link 218 configured to activate a communication interface (not shown) when a user 104 clicks on the link 218. The link 218 provides an alternate way to contact a media provider 106. For example, when the user 104 activates the link 218, a real-time interaction with the media provider 106, such as through online messaging or VoIP, may be provided.

In further embodiments, the optional fields 216 are components of the dynamic media 212 that may be updatable or customizable. In customizable media embodiments, after the dynamic media 212 is selected or received by the user 104, these fields 716 are customized to the user 104. Additionally, as inventory, pricing, or other information changes, some of these fields 216 may be updated. The fields 216 may each display a piece of field information 206 according to metadata associated with each field, in some embodiments. For example, field 1, 216a, may display special promotions or remaining inventory in the vendors' inventory repository 116. Field 2, 216b, may display price information. In exemplary embodiments, the price information is a current price as obtained from the vendor's inventory repository 116. Finally, field 3, 216c, may display vendor contact information.

The fields 216 may be used for different information in other types of dynamic media 200. For example, recipes may include fields 216 to indicate low fat or low sugar variations. News stories may add fields 216 as news events develop to provide continuous coverage of events or a local perspective. Any number of fields 216 may be embodied in the sample media 212.

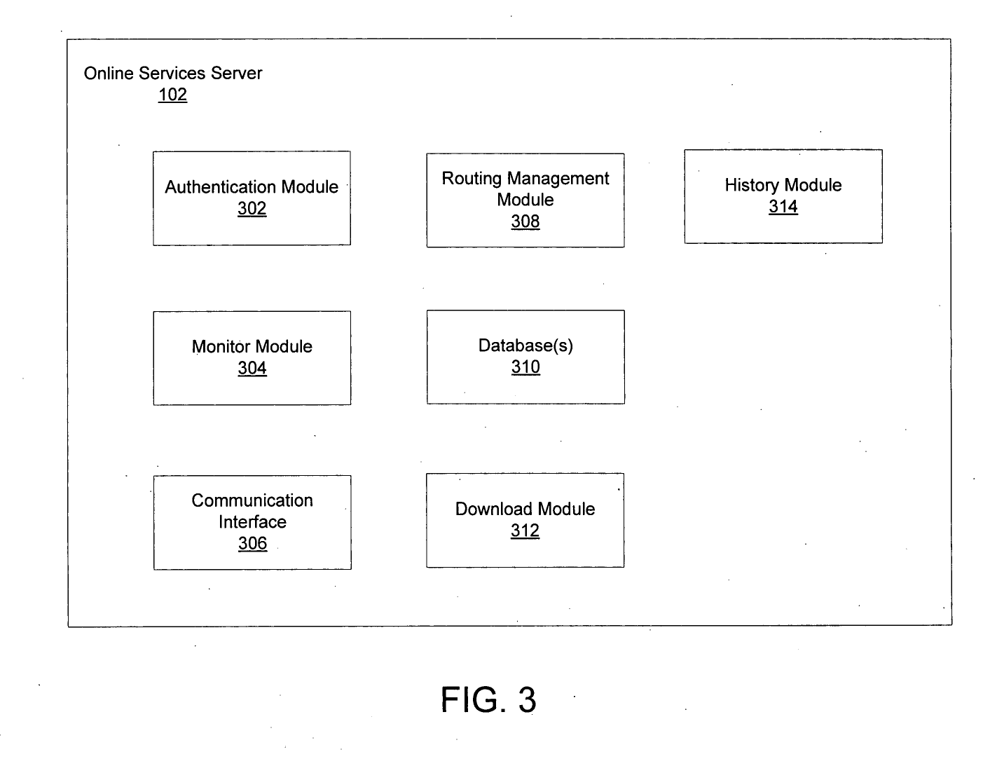

Referring now to FIG. 3, the exemplary online services server 102 is shown in more detail. The online services server 102 comprises an authentication module 302, a monitor module 304, a communication interface 306, a routing management module 308, database(s) 310, a download module 312, and a history tracker 314. In some embodiments, the database(s) 310 comprises a plurality of databases, each storing designated data. For example, the online services server 102 may comprises an authentication database (e.g., containing user 104 and media provider 106 information), a monitor database (e.g., storing transaction information), an history database (e.g., storing media tracking information), and an online services application database (e.g., storing e-commerce plug-ins and modules for e-commerce, e-community, or other applications that may be accessed and downloaded onto the user 104 and vendor 114 devices). In alternative embodiments, the database 310 is located outside of the online services server 102 but is coupled thereto. It should be noted that the online services server 102 may comprise other components not relevant to the functionalities of embodiments of the present invention.

The exemplary authentication module 302 authenticates users 104, media providers 106, e-communities 110 (e.g., an administrator for the e-community 110), and vendors 114. When these members first register with the online services server 102, the members provide data such as a user name, password, and contact information. This information is then stored in the database(s) 310.

Subsequently, authentication may occur seamlessly and unobtrusively to the members. In one embodiment, the authentication process comprises verifying the user name and password supplied by the member with those stored in the database(s) 310. Alternative methods for authenticating members may be utilized, such as, for example, verifying IP addresses in communications sent between members. The authentication information may be received via the communication interface 306. The authentication module 302 then compares the received authentication information to authentication information stored in the database(s) 310. As such, members accessing and utilizing the environment 100 are known to the online services server 102, and based on permissions associated with the member, are enabled to interact with other members. In some embodiments, the authentication module 302 allows for transfer of dynamic media.

In alternative embodiments, the authentication module 302 is optional or not required in order for embodiments of the present invention to be practiced. In these embodiments, a user 104, media provider 106, e-community 110, and/or vendor 114 does not need to be registered/authenticated in order to support dynamic media functionalities. For example, registration/authentication may be performed automatically without the user 104 being required to submit any personal information. In these embodiments, each dynamic media is an instantiation of a node of a closed/private community comprising the media provider 106 and all dynamic media (from the media provider 106) currently in existence. The media provider 106 hosts the ‘authentication process’ and it may be different for each dynamic media accessed by the user 104. Thus, an instantiation is authenticated each time as distinct from the user 104 or computing device, itself.

As such, the authentication process may occur during an initial connection with the system (e.g., login at a start of a session). In alternative embodiments, authentication may occur at other times, such as when the user 104 interacts with a dynamic media. In further embodiments, the user 104 does not need to be authenticated or logged into the online services server 102 in order to interact with the dynamic media (e.g., view, transfer, or receive updates to the dynamic media).

In some embodiments, authentication of the user 104 allows for customization of dynamic media viewed by the user 104. Because the user 104 is now logged in with the online services server 102, updates from the media provider 106 may be provided to the authenticated user 104. Additionally, the online services server 102 may monitor dynamic media viewed by each user 104 and track actions associated with each user 104 with regards to dynamic media (e.g., transferring a dynamic media to other users 104, purchasing via the dynamic media, etc.). The monitored data may then be used by the dynamic media provider 106 to target future media to the user 104.

In some embodiments, the monitor module 304 monitors interactions with dynamic media. Interactions with dynamic media may comprise, but are not limited to, viewing a dynamic media, transferring the dynamic media onto the user's local computing device, transferring the dynamic media to another user 104, purchasing a product shown in the dynamic media, and so forth. All of these interactions may be tracked by the monitor module 304. For example, the online services server 102 may receive or intercept communications containing a copy of the dynamic media being sent between users 104. The monitor module 304 can then update the database(s) 310 with the tracking information.

The routing management module 308, in one embodiment, provides routing instructions that allow for control of pathways taken, for example, by communications containing transferred copies of the dynamic media. In one embodiment, the use of these routing instructions allows the online services server 102 (via the monitor module 302) to monitor the communications by routing a copy of the communication containing the copy of the dynamic media being transfer to the online services server 102.

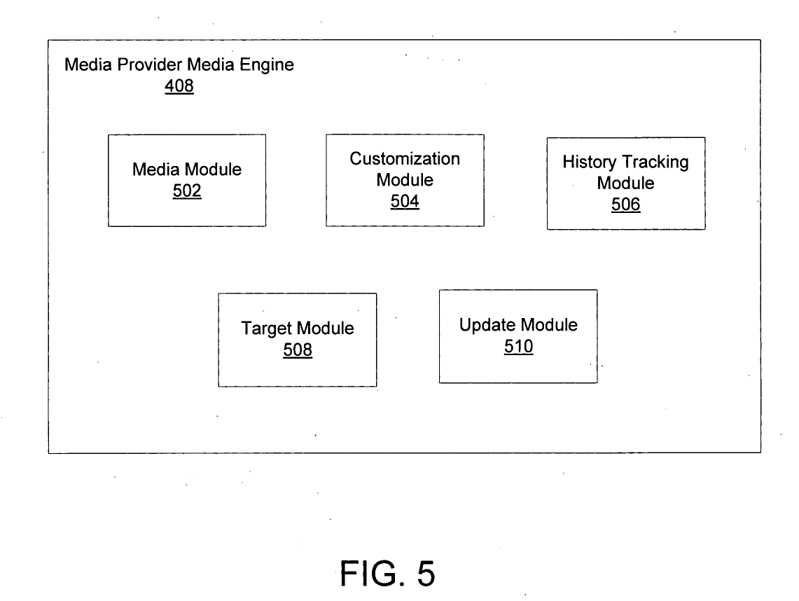

The exemplary download module 312 provides applications and components which create core services modules, as described in more detail in connection with FIG. 5, at the device of the user 104, the media provider 106, e-community 110, and the vendor 114. In alternative embodiments, components of the download module 312 may be embodied, for example, on a CD-ROM for easy distribution. The download module 312 may provide a license agreement, registration, and product updates. In some embodiments, the download module 312 will distinguish a downloading member as a user 104, the media provider 106, e-community 110, and the vendor 114, so as to provide a different version of the application or the core services module component to each type of member. In some embodiments, the core services module components may be the same for all members, while alternative embodiments may comprise different components. Once downloaded by the member, the core services module is configured to meet the needs of the downloading member.

An optional history module 314 may be provided in the online services server 102. In certain embodiments where a history database is maintained at the online services server 102, the history module 314 is configured to maintain a history table for each media it tracks and reproduce the history table for viewing. The history module 314 may also generate an updated media identifier or part of an updated media identifier, as discussed herein, when a new media status is received from the user 104. In alternative embodiments, the history database and the history module 314 are located at the vendor 114 or media provider 106. In yet a further embodiment, the functions of the history module 314 may be performed by the monitor module 304.

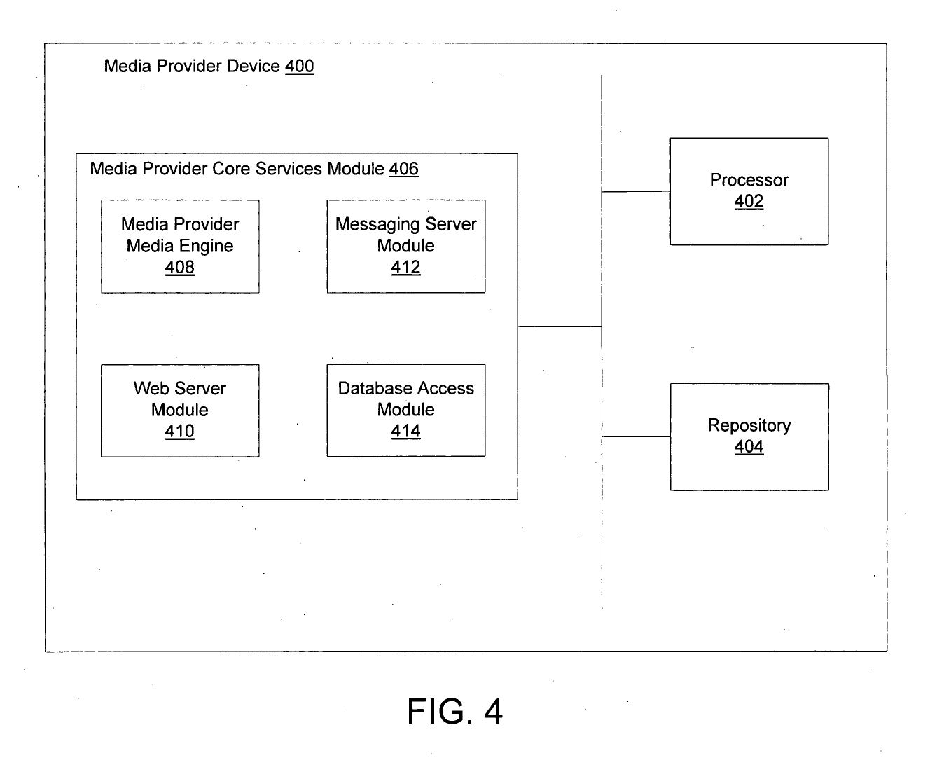

Referring now to FIG. 4, an exemplary media provider computing device 400 is shown. The media provider computing device 400 may comprise a processor 402, a repository 404 or other storage medium, and a media provider core services module 406, which may be stored in memory. Alternative embodiments of the media provider computing device 400 may comprise more, less, or functionally equivalent components. For example, the media provider computing device 400 may comprise other components not necessary for functionalities of embodiments of the present invention.

In some embodiments, the media provider core services module 406 is downloaded from the online services server 102 via the download module 312 and is seamlessly integrated into the media provider computing device 400. In exemplary embodiments, the core services module 406 is downloaded when an online services application is downloaded. For example, the core services module 406 is downloaded when the media provider 106 downloads an e-commerce application or an e-community application as described in related U.S. patent application Ser. No. 11/214,515 entitled “Managed E-Commerce Trading,” and U.S. patent application Ser. No. 11/251,316 entitled “Managed E-Commerce Trading Environments,” which are incorporated by reference. That is the core service module 406 is an inherent part of all online services applications provided by the online services server 102. Once the core services module 406 is installed on the media provider computing device 400, regardless of whether an online services application is running, the media provider 106 may provide dynamic media. In alternative embodiments, the core services module 406 may be downloaded separate from any online services application.

The media provider core services module 406 may comprise a media provider media engine 408, a web server module 410, a messaging server module 412, and a database access module 414. In some embodiments, the core services module 406 may also comprise a specialized browser technology optimized for communication using the Internet without depending on existing HTML/XML browser technology. The media provider computing device 400 shown in FIG. 4 is exemplary and may comprise other components not functionally related to embodiments of the present invention.

The media provider media engine 408, which is described in more detail in connection with FIG. 5, is configured to provide dynamic media to a requesting user 104. The dynamic media may be customized to the user 104 or updated as real-time information is incorporated into the dynamic media and forwarded to the user 104. In further embodiments, the dynamic media may be targeted to the user 104.

The exemplary web server module 410 is configured to allow web-based interactions with other system installations. Additionally, the web server module 410 may include messaging or Voice-over Internet Protocol (VoIP) technology.

The exemplary messaging server module 412 is configured to ensure robust communication with other members. The messaging server 412 may provide communication to the users 104, for example, via e-mail or a link associated with the dynamic media, as will be discussed in more detail below.

In some embodiments, the database access module 414 provides access to real-time information and updates in the media provider's own repository 112 (e.g., storage device 404) such as updated news, directory information, inventory, pricing, and the like. This information may be used by a customization module in the media provider media engine 408 to update dynamic media as will be discussed in more detail in connection with FIG. 5.

It should be noted that a user computing device may comprise similar components and functionalities as those of the media provider computing device 400 in order to provide the dynamic media to the user 104.

FIG. 5 illustrates the media provider media engine 408 in more detail. The media provider media engine 408 may comprise a media module 502, a customization module 504, a history tracking module 506, a target module 508, and an update module 510.

The media module 502 provides the selected dynamic media to the user 104. In exemplary embodiments, the media provider media engine 408 receives a request for a dynamic media from the user 104. The request may be via the messaging server 412, for example. Based on the media identifier 208 of the requested dynamic media, the media module 502 provides a version of the dynamic media to the user 104 by sending data necessary for the recreation of the version of the dynamic media at the user 104 device.

In some embodiments, the version of the dynamic media is customized. The customization module 504 provides the data to customize the dynamic media. In exemplary embodiments, the customization module 504 may send instructions to the user 104 device to provide user preferences. In some embodiments, user preference information may then be received from the user 104 device. Based on the user preference information, the customization module 504 will create a version of the dynamic media that will be customized to the user 104. For example, if the user preference information indicates that the user 104 is located in California, the customization module 504 takes that information and determines data to include in the dynamic media which is specific to California (e.g., include sales tax information in price or provides local travel packages that are on sale). In alternative embodiments, the user preference information may be sent with the initial request for the dynamic media or at any time after the version of the dynamic media is received from the media provider 106.

The history tracking module 506 is configured to allow the media provider 106 to track versions of their dynamic media with the users. The history tracking module 506 may also track other interactions performed by the user 104 with respect to their dynamic media. Tracking allows the media provider 106 to determine effective media for the user 104. If the user 104 has, for example, consistently selected certain dynamic media from the media provider 106 or purchased products via some dynamic media, the media provider 106 can track these interactions and offer customized dynamic media to the user. Thus, based on the user's past behavior, future media can be customized and, in some embodiments, pushed to the user 104. The pushed media can replace expired versions of dynamic media on the user 104 computing device or may be offered to the user 104, for example, via e-mail or via the media provider's website the next time the user 104 visits the website. In some embodiments, the history tracking module 506 is optional.

The target module 508 is configured to provide targeted dynamic media to the user 104. In exemplary embodiments, the target module 508 compiles a list of dynamic media which the media provider 106 wants to “push” to users 104. The target module 508 works with the customization module 504 to assess and review user preferences and past behaviors of the users 104. The selected users 104 may currently have versions of the media provider's media on their device or have, in the past, interacted with the media provider 106. Relevant dynamic media may then be provided to the users 104. The relevant dynamic media may be customized to the user 104, according to some embodiments.

The exemplary update module 510 determines if any dynamic media from the media provider 106 should be updated or replaced. In exemplary embodiments, the update module 510 monitors the database repository 112 for changes that may trigger an update to dynamic media. In these embodiments, the update module 510 may check the database repository 112 for updates at predetermined times. If an update is available, the update module 510 triggers the media module 502 and the customization module 504 to generate and provide the updated dynamic media to the user 104. The updated dynamic media may also be provided to other locations on the network 108 (e.g., on the media provider's website).

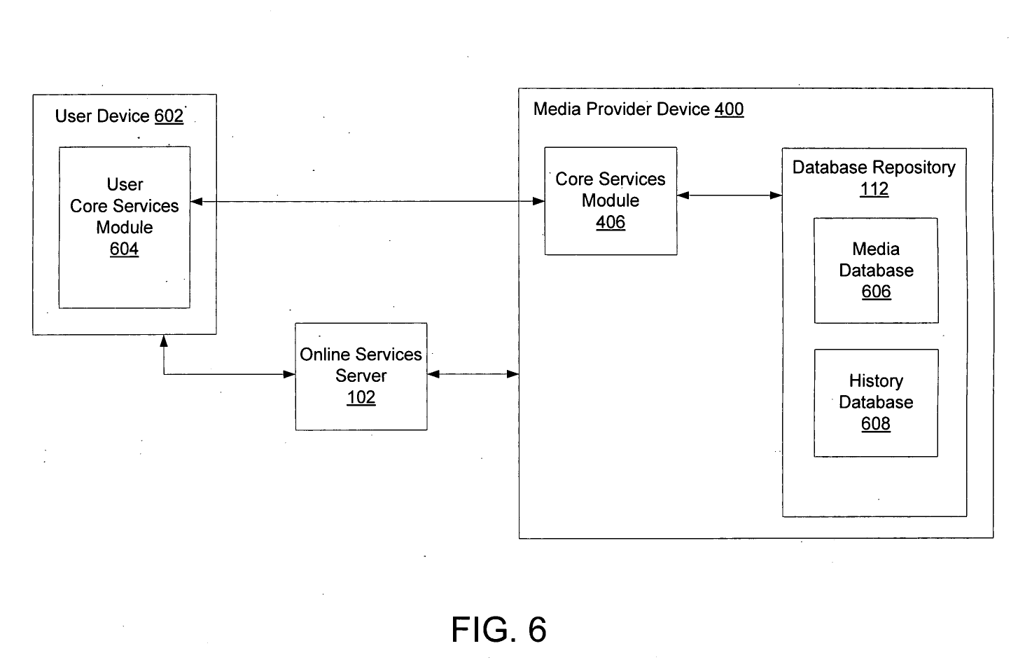

Referring now to FIG. 6, an exemplary communication path between a user device 602 and the media provider device 400 is shown. In some embodiments, the user device 602 may comprise a user core services module 604. When the user 104 selects a dynamic media, the user core services module 604 may be triggered to communicate with the media provider device 400.

In exemplary embodiments, a request for the selected dynamic media may be sent to the core services module 406 of the media provider 106. As previously discussed, the media provider core services module 406 will provide the selected dynamic media to the user device 602. The core services module 406 may access a media database 606 to obtain relevant information to generate the dynamic media. In some embodiments, the dynamic media may be customized to the user 104.

The media provider device 400 may also track the dynamic media provided to the user device 602. Tracking information may be stored in a history database 608. The history database 608 may subsequently be used to provider user past behavior preferences for customization of dynamic media (e.g., a history of dynamic media previously selected or products purchased via the previous dynamic media). The history database 608 may also be used to provide data for targeting dynamic media to the user 104.

In alternative embodiments, the online services server 102 may act as an intermediary between the user device 602 and the media provider device 400. For example, the user device may send a request for the dynamic media via the online services server 102 to the media provider device 400. Similarly, the media provider device 400 may send the dynamic media via the online services server 102. In these embodiments, the online services server 102 is enabled to track the communications and the dynamic media.

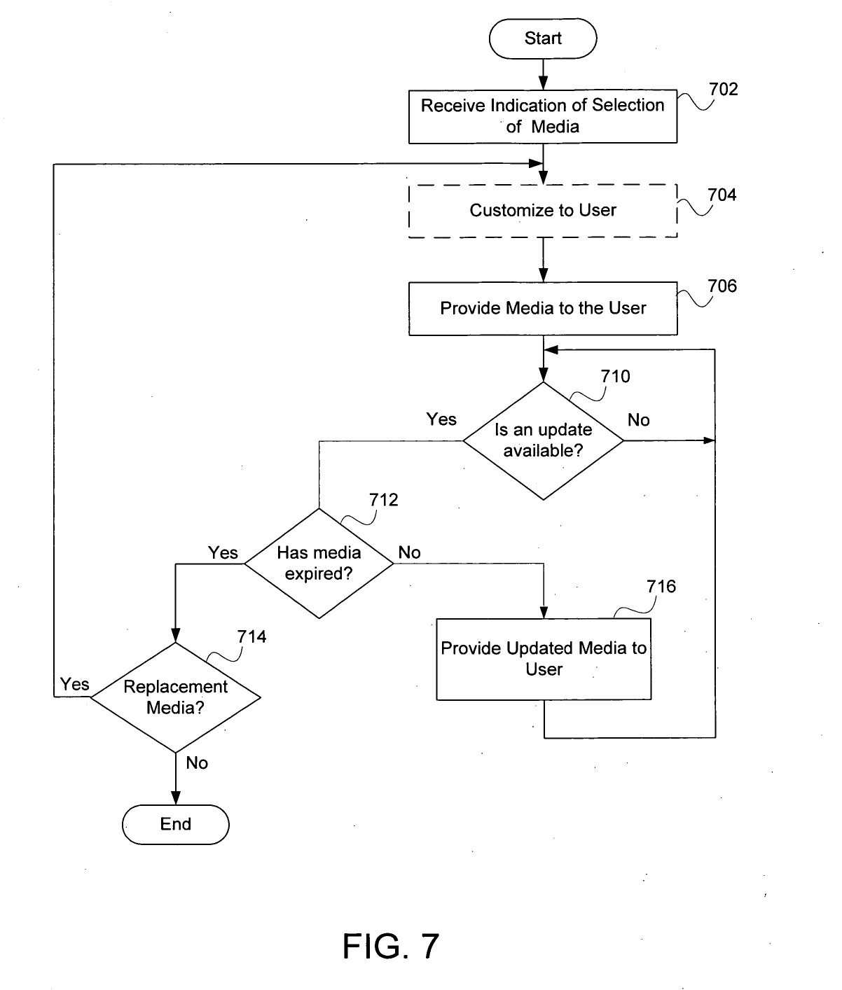

Referring now to FIG. 7, an exemplary flowchart of a method for providing a version of a dynamic media to the user 104 is shown. In step 702, the media provider 106 receives an indication that their dynamic media is selected. In some embodiments, the user 104 may select the dynamic media by activating a script embedded in the HTML section of the dynamic media. In these embodiments, the activation of the script will trigger the user core services module 604 at the user device 602 to initiate communications with the media provider 106. In other embodiments, the dynamic media is “dragged and dropped” or “copied and pasted.” In exemplary embodiments, the selected media comprises a parent address 204 which provides contact information to the media provider 106 and a media identifier 208 which identifies the specific dynamic media. Other methods of activating a link to the media provider 106 are contemplated.

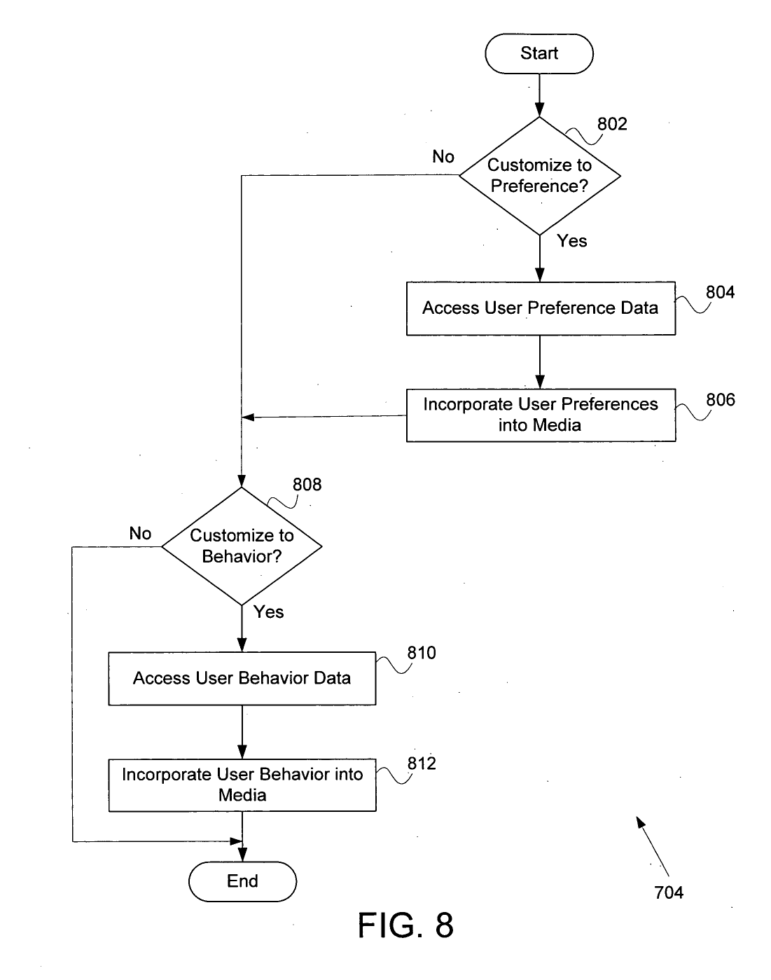

In step 704, the media provider 106 determines if the selected media should be customized to the user. Some embodiments of the dynamic media are customizable to the user 104, while other embodiments of the dynamic media are not customizable. Step 704 will be discussed in more detail in connection with FIG. 8. The dynamic media is then provided to the user in step 706.

In step 710, the update module 510 determines if an update is available for the dynamic media. In exemplary embodiments, the update module 510 will monitor the repository 112 for any changes that will affect the dynamic media. If changes that affect dynamic media are detected, the update module 510 determines if the affected dynamic media has expired in step 712. In some embodiments, a dynamic media may expire after a certain period of time. For example, an advertisement dynamic media may only be available for a limited amount of time. In these situations, updates to the dynamic media may not be necessary since the dynamic media is no longer valid.

If the dynamic media has expired, then in step 714, a determination is made (e.g., by the update module 510) as to whether a replacement dynamic media should be forwarded. The replacement dynamic media may be directed to same or similar subject matter as the expired dynamic media. Alternatively, the replacement dynamic media may be based on and/or customized to user preferences or prior behaviors.

If the dynamic media has not expired, then the update is incorporated into a new version of the dynamic media and provided to the user in step 716.

Referring now to FIG. 8, a flowchart of an exemplary method for customizing the dynamic media to the user 104 (step 704) is shown. In step 802, a determination is made as to whether a requested dynamic media can be customized to user preferences.

If the dynamic media can be customized, then in step 804 the customization module 504 assesses the user preference data. In one embodiment, a customization module 504 of the media provider media engine 406 sends a request for user preference information to the user core services module 604. The user core services module 604 responds with the user preference information. In an alternative embodiment, the user preference information may be provided without instruction from the customization module 504 (e.g., with the initial communication/request for media from the user core services module 604).

The customization module 504 then reviews the user preference information and determines appropriate data to customize the dynamic media with. For example, if the user has a preference for Spanish language media, the version of the selected media may be a Spanish version. The appropriate data to customize the dynamic media with may be, in exemplary embodiments, received from coupled repositories (e.g., database repository 112) and incorporated into the version of the dynamic media by the media module 502 in step 806.

In some embodiments, the dynamic media may be customizable based on user behavior. In step 808, the customization module 504 determines if the selected media can be customized based on past behavior. If the dynamic media is customizable to user behavior, the user behavior information is accessed in step 810. In some embodiments, user behavior information with the media provider 106 is stored by the history tracking module 506. User behavior information may also be stored at the user device 602 and accessed when requested by the customization module 504. In further embodiments, some user behavior information may also be stored with the online services server 102. User behavior may include previously selected dynamic media and media types (e.g., preference for travel and weather information for Sydney, Australia) and interactions with dynamic media and media types (e.g., purchases for a certain type of product from a certain type of media).

The appropriate data to customize the dynamic media with is, in exemplary embodiments, received from a coupled repository (e.g., database repository 112) and incorporated into the version of the dynamic media by the media module 502 in step 812.

The method of FIG. 8 is exemplary. Alternative embodiments may comprise more or less steps, and steps may be practiced in a different order. For example, steps 808-812 may be optional, or may occur prior to steps 802-806.

It should also be noted that user behavior may be considered a subset of user preferences. That is, the user preferences include the user's past actions with dynamic media. Therefore, steps 808-812 may be incorporated into steps 802-806.

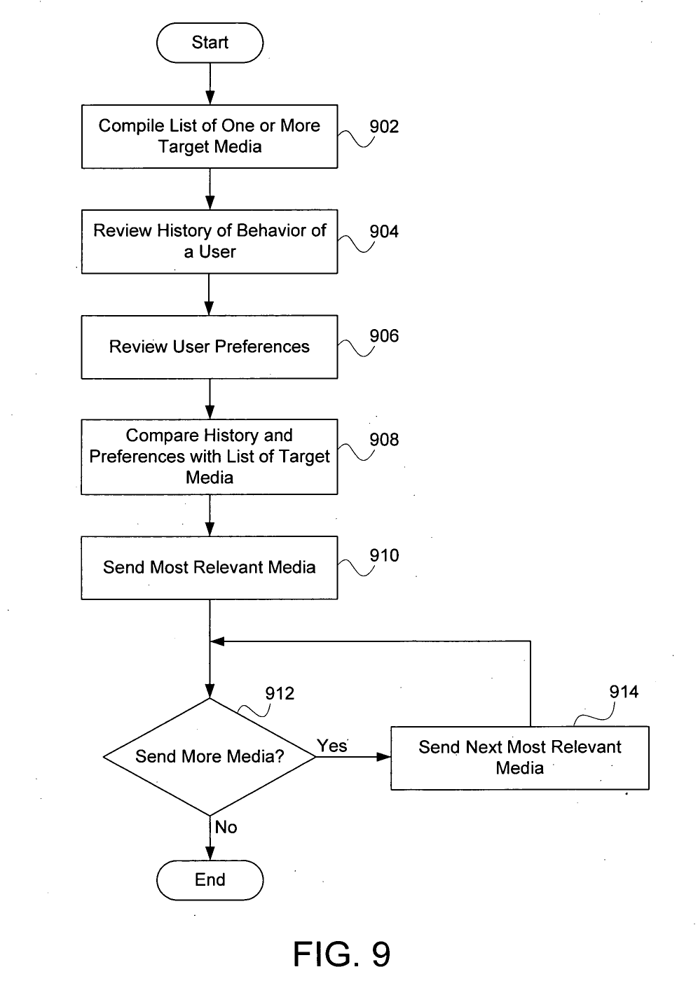

Referring now to FIG. 9, an exemplary method for targeting dynamic media to the user 104 is provided. In exemplary embodiments, the media provider 106, based on user preferences and behavior, can provide dynamic media or offers for dynamic media that are targeted to the user 104.

In step 902, the target module 508 compiles a list of one or more target media that a media provider 106 wants to push to users 104. The users 104 may be selected because the users 104 currently have versions of the media provider's dynamic media on their user devices 602 or have, in the past, interacted with the media provider 106.

The target module 508 then works with the customization module 504 to access a history of behavior/behavior data (step 904) and user preferences (step 906) of selected users 104. It should also be noted that user behavior may be considered a subset of user preferences. That is, the user preferences include the user's past actions with dynamic media. Therefore, steps 904 and 906 may be combined into a single user preference step.

A comparison of the history of behavior and user preferences is made with the list of target media, in step 908, to determine a most relevant target media to provide to selected users 104. In step 910, the most relevant target media is sent to the user 104. In some embodiments, a version of the target media is customized to the user behavior and/or user preferences.

If more relevant target media is to be sent (step 912), a next most relevant target media may be sent in step 914. It should be noted that in lieu of sending the version of the target media to the user 104, an invitation to receive the target media may be sent to the user (e.g., an e-mail with a link or script that the user 104 can activate).

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for providing dynamic media to user comprising:
receiving a request from a user for a dynamic media, the dynamic media being identified by a media identifier; and
providing the dynamic media to the user.

2. The method of claim 1 further comprising customizing the dynamic media to the user.

3. The method of claim 2 wherein customizing the dynamic media comprises requesting user preferences from a device associated with the user.

4. The method of claim 2 wherein customizing the dynamic media comprises assessing user preferences associated with the user.

5. The method of claim 2 wherein customizing the dynamic media comprises assessing user past behavior associated with the user.

6. The method of claim 1 further comprising determining if an update is available for the dynamic media, and providing an updated dynamic media if the update is available.

7. The method of claim 1 further comprising determining if the dynamic media has expired.

8. The method of claim 1 further comprising providing a replacement dynamic media to the user.

9. The method of claim 1 wherein the request is a drag and drop of the dynamic media to a device associated with the user.

10. The method of claim 1 wherein the request is a communication triggered by a script embedded in a selected dynamic media.

11. The method of claim 1 further comprising providing a targeted media to the user.

12. A method for targeting media to a user comprising:
accessing user preferences;
determining if at least one target media is appropriate for the user based on the user preferences; and
providing the at least one target media to the user.

13. The method of claim 12 wherein the user preferences comprise user past behavior.

14. The method of claim 12 further comprising customizing the at least one target media based on the user preferences.

15. The method of claim 12 further comprising determining a list of appropriate users to provide the at least one target media based on user preferences.

16. A system for providing dynamic media comprising:
a media module configured to provide a dynamic media based on request received from a user; the request comprising a media identifier identifying the dynamic media.

17. The system of claim 16 further comprising a customization module configured to customize the dynamic media for the user based on user preferences.

18. The system of claim 17 wherein the user preferences comprise user past behavior.

19. The system of claim 17 wherein the customization module is further configured to request the user preferences from a device associated with the user.

20. The system of claim 16 further comprising a target module configured to provide at least one target media to the user.

21. The system of claim 16 further comprising an update module configured to determine if an update is available for the dynamic media.

22. The system of claim 16 further comprising a history tracking module configured to track one or more dynamic media the user has interacted with.
